(19) United States
(12) Patent Application Publication
(10) Pub. No.: US 2024/0039028 A1
(43) Pub. Date: Feb. 1, 2024

(54) MANUFACTURING DEVICE FOR ASSEMBLED BATTERY

(71) Applicant: TOYOTA JIDOSHA KABUSHIKI KAISHA, Toyota-shi (JP)

(72) Inventors: Shintaro MIYATA, Nisshin-shi (JP); Yoshinori SHIBATA, Nagoya-shi (JP); Tomo FUKAMI, Nagoya-shi (JP); Hiroki KITOH, Tokai-shi (JP)

(73) Assignee: TOYOTA JIDOSHA KABUSHIKI KAISHA, Toyota-shi (JP)

(21) Appl. No.: 18/200,258

(22) Filed: May 22, 2023

(30) Foreign Application Priority Data
Jul. 27, 2022 (JP) 2022-119576

(51) Int. Cl. H01M 10/04; H01M 50/507; H01M 50/516; B23K 37/04

(52) U.S. Cl. CPC H01M 10/0404; H01M 50/507; H01M 50/516; B23K 37/0408; B23K 26/21

(57) ABSTRACT

An assembled battery includes a plurality of battery cells stacked in a first direction, each battery cell including a terminal on a surface facing a second direction that intersects the first direction, and a busbar being welded to the terminal. A manufacturing device includes: a plurality of pressing pieces arranged along the first direction, a tip of each of the pressing pieces in the second direction facing the respective terminal with the busbar interposed between the pressing piece and the terminal; a rotor that extends along the first direction and that is rotated by an actuator, the rotor being engaged with the pressing pieces and being configured to press the pressing pieces against the busbars when rotated about an axis; and a welder that welds the busbars and the terminals. The welder welds the busbars to the terminals while the rotor presses the busbars against the terminals.

### CROSS-REFERENCE TO RELATED APPLICATION

This application claims priority to Japanese Patent Application No. 2022-119576 filed on Jul. 27, 2022 incorporated herein by reference in its entirety.

### BACKGROUND

### 1. Technical Field

The technology disclosed in the present specification relates to an assembled battery manufacturing device.

### 2. Description of Related Art

The assembled battery includes a plurality of battery cells stacked in a first direction. Each battery cell has a terminal on a surface facing a second direction that intersects the first direction, and a busbar is welded to the terminal. The assembled battery and its manufacturing device described above are disclosed in WO 2017/130705. The busbar is welded to the terminal of the battery cell. In the manufacturing device disclosed in WO 2017/130705, the busbar is welded to the terminal while the busbar is pressed against the terminal with a jig.

### SUMMARY

In order to quickly weld a plurality of busbars, it is preferable to weld each busbar to each terminal while simultaneously pressing the busbar against each of the terminals. The manufacturing device has a plurality of pressing pieces facing each of the terminals with the busbar interposed therebetween. A large force is required to simultaneously press the pressing pieces against the busbars. If a beam supported at both ends is translated and pressed against the pressing pieces, the beam will be greatly bent by the reaction force received from the pressing pieces. The present specification provides a manufacturing device suitable for simultaneously pressing a plurality of pressing pieces against a plurality of busbars.

In describing the manufacturing device disclosed in the present specification, the assembled battery will be described first. The assembled battery includes a plurality of battery cells stacked in a first direction. Each battery cell has a terminal on a surface facing a second direction that intersects the first direction, and a bus bar is welded to the terminal. The manufacturing device disclosed in the present specification includes: a plurality of pressing pieces arranged along the first direction, a tip of each of the pressing pieces in the second direction facing the respective terminal with the busbar interposed between the pressing piece and the terminal; a rotor that extends along the first direction and that is rotated by an actuator, the rotor being engaged with the pressing pieces and being configured to press the pressing pieces against the busbars when rotated about an axis; and a welder that welds the busbars and the terminals. The welder welds the busbars to the terminals while the rotor presses the busbars against the terminals.

When the rotor rotates, the reaction force of the force that pushes the pressing pieces is dispersed into the translational force that pushes the rotor and the moment that twists the rotor. Since the reaction force of the force that pushes the pressing pieces is received by the bending rigidity and the torsional rigidity of the rotor, the deflection of the rotor is smaller than when the pressing pieces are pushed by a beam that moves in translation. The manufacturing device disclosed in the present specification is suitable for simultaneously pressing a plurality of pressing pieces against a plurality of busbars.

An example of the rotor includes a shaft rotated by the actuator and a plurality of contact pieces engaged with the shaft. Each of the contact pieces is in contact with the corresponding one of the pressing pieces. Engagement points between the contact pieces and the shaft are preferably dispersed around the shaft when viewed from the first direction. The moment applied to the shaft from the contact pieces is evenly applied around the shaft.

A spring may be interposed between the shaft and each of the contact pieces. The spring has elasticity in a circumferential direction of the shaft. A load is evenly applied to each busbar even if there are positional variations of the busbars in the second direction.

An example of the contact piece is a pinion gear. In that case, the pressing piece preferably has a rack gear that engages with the pinion gear.

Details of the techniques disclosed in the present specification and further modifications will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of an assembled battery;

FIG. 2 is a perspective view of two battery cells, a separator, and a busbar;

FIG. 3 is a front view of an assembled battery manufacturing device;

FIG. 4 is a plan view of the manufacturing device;

FIG. 5 is an explanatory diagram of forces applied to a rotor;

FIG. 6A is a diagram illustrating forces applied to a shaft by each of four pinion gears;

FIG. 6B is a diagram illustrating forces applied to the shaft by each of the four pinion gears;

FIG. 6C is a diagram illustrating forces applied to the shaft by each of the four pinion gears;

FIG. 6D is a diagram illustrating forces applied to the shaft by each of the four pinion gears; and

FIG. 7 is a front view of an assembled battery manufacturing device of a modification.

### DETAILED DESCRIPTION OF EMBODIMENTS

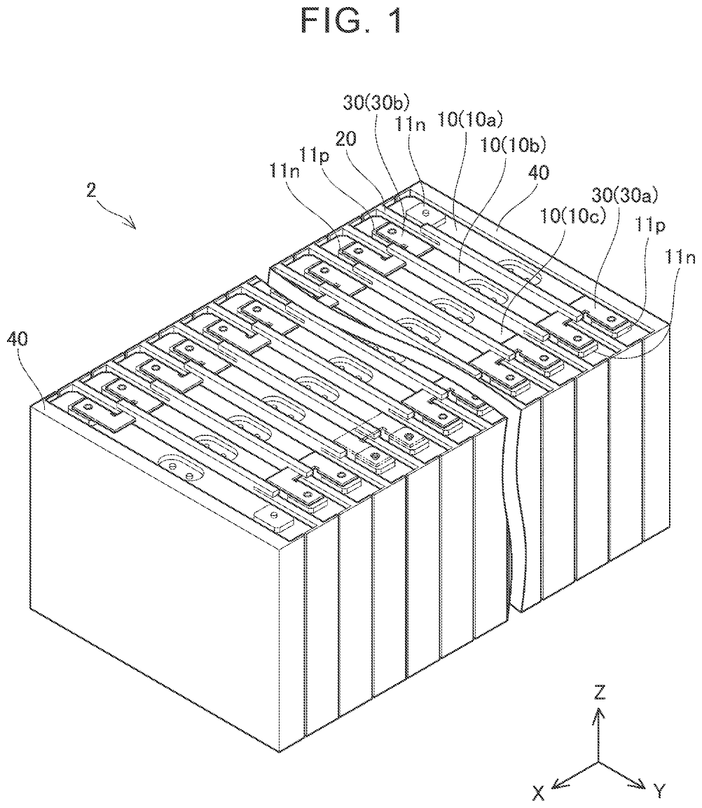

An assembled battery 2 will be described prior to describing a manufacturing device of an embodiment. FIG. 1 shows a perspective view of the assembled battery 2. The assembled battery 2 has a structure in which a plurality of battery cells 10 and a plurality of separators 20 are alternately stacked one by one. In FIG. 1, reference signs are omitted for some battery cells and some separators. Also, in FIG. 1, the illustration of the central portion of the assembled battery 2 is omitted. When individually representing the three battery cells 10 on the right side of FIG. 1, reference signs 10a, 10b, and 10c are used. The X direction of the coordinate system in FIG. 1 corresponds to the stacking direction of the plurality of battery cells 10. In the following figures as well, the X direction of the coordinate system in the figures corresponds to the stacking direction.

End plates 40 are attached to both ends of the stack of the battery cells 10 and the separators 20. The stack of the battery cells 10, the separators 20, and the end plates is bound by a band or a frame and housed in a case. Illustrations of the band or the frame and the case are omitted.

A positive terminal llp and a negative terminal 1 ln are provided on one surface of the battery cell 10 (the surface facing the +Z direction in the coordinate system in the figure). The battery cells 10 are arranged such that the positive terminals 11p and the negative terminals 11n are alternately arranged in the stacking direction (X direction). The positive terminal 11p of the rightmost battery cell 10a in FIG. 1 and the negative terminal 11n of the adjacent battery cell 10b are connected by a busbar 30 (30a). The positive terminal 11p of the battery cell 10b and the negative terminal 11n of the adjacent battery cell 10c are connected by a busbar 30 (30b). By connecting the positive terminal 11p and the negative terminal 11n of the adjacent battery cells 10 in this way, all the battery cells 10 are connected in series. Although not shown, the end plates 40 are provided with a positive terminal and a negative terminal that terminate the series connection of the battery cells 10.

Hereinafter, when the positive terminal 11p and the negative terminal 11n are referred to without distinction, they are referred to as the terminal 11. The terminals 11 adjacent in the X direction are connected by the busbars 30.

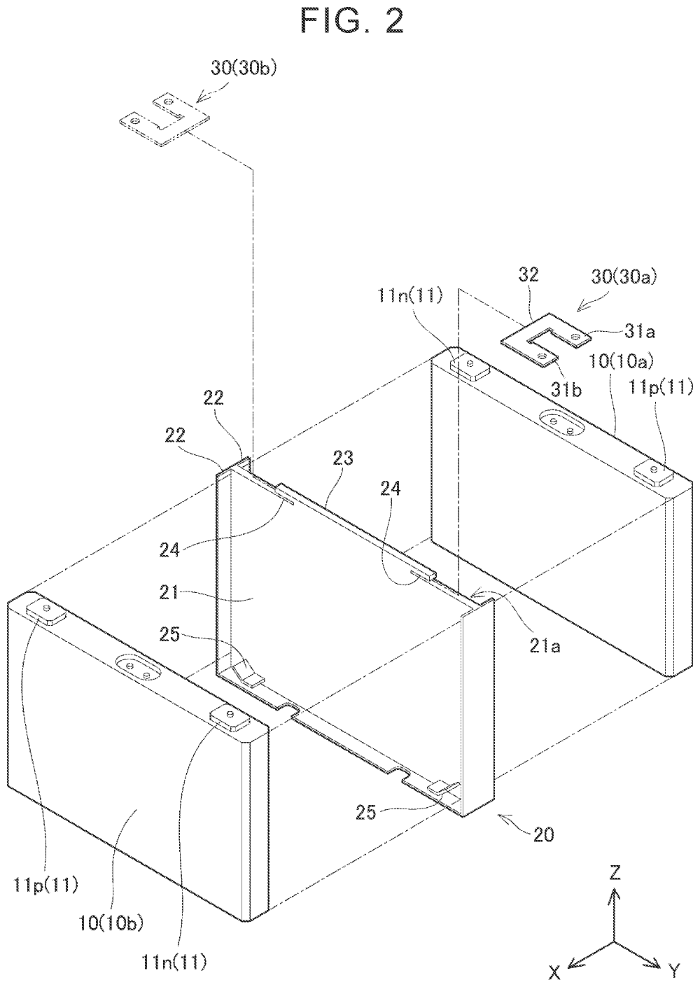

FIG. 2 shows a perspective view of each of the battery cell 10, the separator 20, and the busbar 30. The separator 20 is made of resin. The separator 20 includes a partition plate 21 sandwiched between adjacent battery cells 10 (10a, 10b). The partition plate 21 is rectangular and has a frame 22 extending along three sides excluding an upper side 21a. The frame 22 is provided on both sides of the partition plate 21. The battery cell 10 fits into the frame 22. One of the frames 22 on both sides of the partition plate 21 is made so that the battery cell 10 is press-fitted, and the other is made larger (broader) than the one frame 22 so that the battery cell 10 can be loosely fitted.

The partition plate 21 is provided with lips 25 that contact the bottom surface of the battery cell 10 fitted to the frame 22. The lips 25 are elastic projections that bend in the vertical direction. The lips 25 support the battery cell 10 fitted to the frame 22 from below.

A rib 23 extends upward from the upper side 21a of the partition plate 21. Slits 24 are provided between the right and left ends of the rib 23 and the upper side 21a of the partition plate 21 when viewed from the X direction (stacking direction) in the figure. When viewed from the X direction, the slit 24 has a U shape in which the upper and lower sides and the center side of the separator 20 in the horizontal direction are closed.

The busbar 30 has a U-shape as a whole, and includes two arm portions 31a, 31b and a bottom portion 32 connecting the arm portions 31a, 31b. The busbar 30 is made of a metal plate. The terminals 11 of the battery cells 10 are also made of metal, and the busbars 30 and the terminals 11 are joined by welding.

The busbar 30 is sandwiched between the slits 24 and supported. More specifically, the plate-shaped bottom portion 32 of the busbar 30 is inserted into the slit 24 from the horizontal direction (the Y direction of the coordinate system in the figure).

One busbar 30 is attached to one separator 20. In FIG. 2, the busbar 30 (30a) is attached to the slit 24 on the right side of the separator 20, so the busbar 30 (30b) is not attached to the slit 24 on the left side (in FIG. 2, the busbar 30 (30b) that is not actually attached is drawn in imaginary lines). In another separator 20, the busbar 30 (30b) is attached to the slit 24 on the left side, and the busbar 30 (30a) is not attached to the slit 24 on the right side.

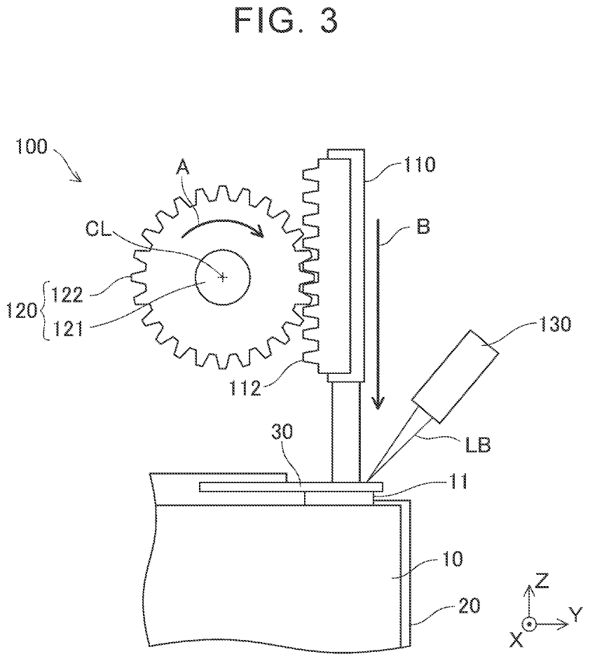

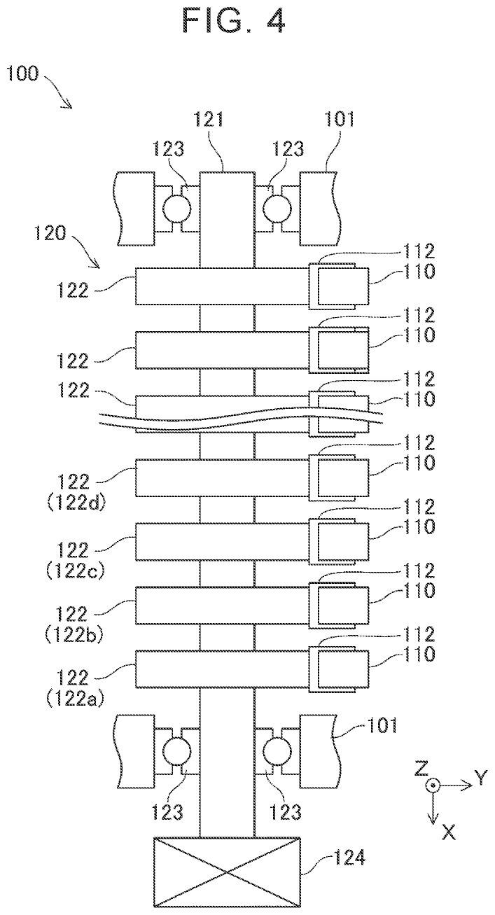

A manufacturing device 100 for the assembled battery 2 will be described. FIG. 3 shows a front view of the manufacturing device 100, and FIG. 4 shows a plan view of the manufacturing device 100. A stack of a plurality of battery cells 10 and a plurality of separators 20 is set in the manufacturing device 100. In FIG. 4, illustration of the stack is omitted. In FIGS. 3 and 4 as well, the X direction of the coordinate system corresponds to the stacking direction of the battery cells 10 and the separators 20. Each separator 20 holds a busbar 30.

The manufacturing device 100 is a device for welding the busbars 30 to the terminals 11 of the battery cells 10. The manufacturing device 100 includes a plurality of pressing pieces 110 arranged in the X direction, a rotor 120 for pushing the pressing pieces 110 toward the busbars 30, and a welder 130. The pressing piece 110 is provided in a housing 101 so as to be movable in the Z direction of the coordinate system in the figure, but the supporting structure of the pressing piece 110 is omitted from the figure. In FIG. 3, illustration of the housing 101 is also omitted. Although the welder 130 is also supported by the housing 101, its support structure is also omitted from the illustration.

The plurality of pressing pieces 110 is arranged along the X direction. The tip (lower end) of each pressing piece 110 faces the terminal 11 with the busbar 30 interposed therebetween. In other words, the terminal 11 is provided on the surface of the battery cell facing the Z direction, and the pressing piece 110 is supported by the housing 101 (not shown in FIG. 3) so as to be movable in the Z direction and so that the tip of the pressing piece 110 faces the terminal 11. The pressing piece 110 is provided with a rack gear 112.

The rotor 120 has a shaft 121 whose both ends are rotatably supported by the housing 101 and a plurality of pinion gears 122 engaged with the shaft 121. The shaft 121 is rotatably supported by the housing 101 via a bearing 123. The shaft 121 is rotated around an axis CL by a motor 124.

Each of the plurality of pinion gears 122 is engaged with the rack gear 112 of the corresponding pressing piece 110. In other words, each of the plurality of pinion gears 122 (contact pieces) is engaged with the rack gear 112 of the corresponding pressing piece 110. As shown in FIG. 3, when the shaft 121 rotates in the direction of the arrow A, the pressing piece 110 is pushed in the direction of the arrow B, and the pressing piece 110 presses the busbar 30 against the terminal 11.

In the manufacturing device 100, the welder 130 irradiates a welding laser beam LB toward the busbar 30 while the busbar 30 is pressed against the terminal 11. The busbar 30 is welded to the terminal 11 by the welding laser beam LB.

As shown in FIG. 4, the plurality of pressing pieces 110 is arranged in the X direction, and each pressing piece 110 presses the busbar 30 (not shown in FIG. 4) against the terminal 11. The welder 130 sequentially welds the plurality of busbars 30 to the terminals 11. As shown in FIG. 1, the terminals 11 of the battery cells 10 are arranged in

two rows. After the busbars 30 are welded to the terminals 11 in one row, the stack of the battery cells 10 and the separators 20 is rotated 180 degrees around the vertical axis. Then, the welder 130 welds the other busbars 30 to the terminals 11 while the pressing pieces 110 press the other busbars 30 against the terminals 11 in the other row.

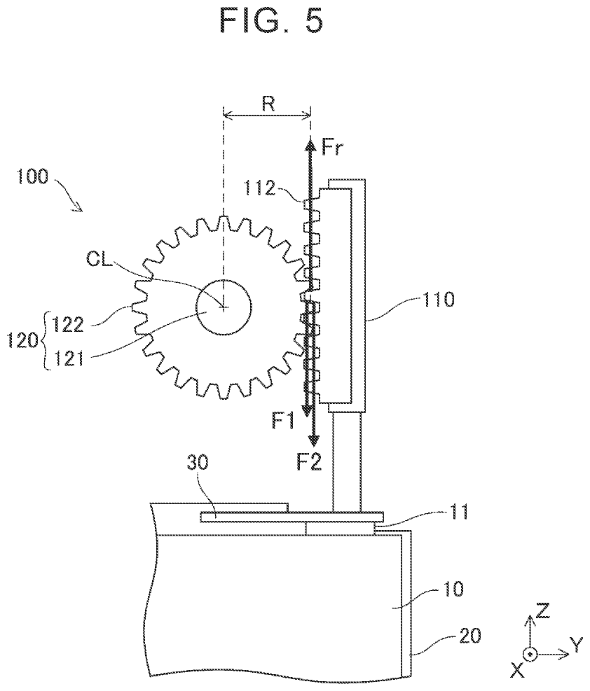

Advantages of the manufacturing device 100 will be described. FIG. 5 shows an explanatory diagram of forces applied to the rotor 120. The rotor 120 that presses the pressing piece 110 against the busbar 30 receives a pressure reaction force Fr from the pressing piece 110. The rotor 120 receives the pressure reaction force Fr with a force F1 and a force F2. The force F1 is a force resulting from the bending rigidity Kz in the Z direction of the shaft 121 of the rotor 120, and the force F2 is a force resulting from the torsional rigidity Ky of the shaft 121. If the deflection of the shaft 121 in the Z direction is represented by the symbol dZ and the torsion angle of the shaft 121 is represented by the symbol dY, the forces F1 and F2 are represented by the following formulas.

F1=Kz×dZ

F2=Ky×dY×R

As a result, the force (pressure reaction force Fr) that the rotor 120 receives from the pressing piece 110 is expressed by the formula Fr=F1+F2=Kz×dZ+Ky×dY×R (where the symbol R is the distance from the axis CL of the shaft 121 to the point of action of the pressure reaction force Fr).

Since the torsional rigidity Ky of the shaft 121 receives part of the pressure reaction force Fr, the deflection dZ of the shaft 121 in the Z direction is reduced. In other words, its advantages are as follows. In the manufacturing device 100, the shaft 121 supported at both ends presses the plurality of busbars 30 against the terminals 11 via the plurality of pressing pieces 110. The shaft 121 receives a reaction force (pressure reaction force Fr) of the force that presses the busbars 30. The pressure reaction force Fr is dispersed into the force F1 caused by the bending rigidity Kz of the shaft 121 and the force F2 caused by the torsional rigidity Ky. Since part of the pressure reaction force Fr is converted into the torsion angle dY of the shaft 121, the deflection dZ of the shaft 121 in the Z direction is reduced.

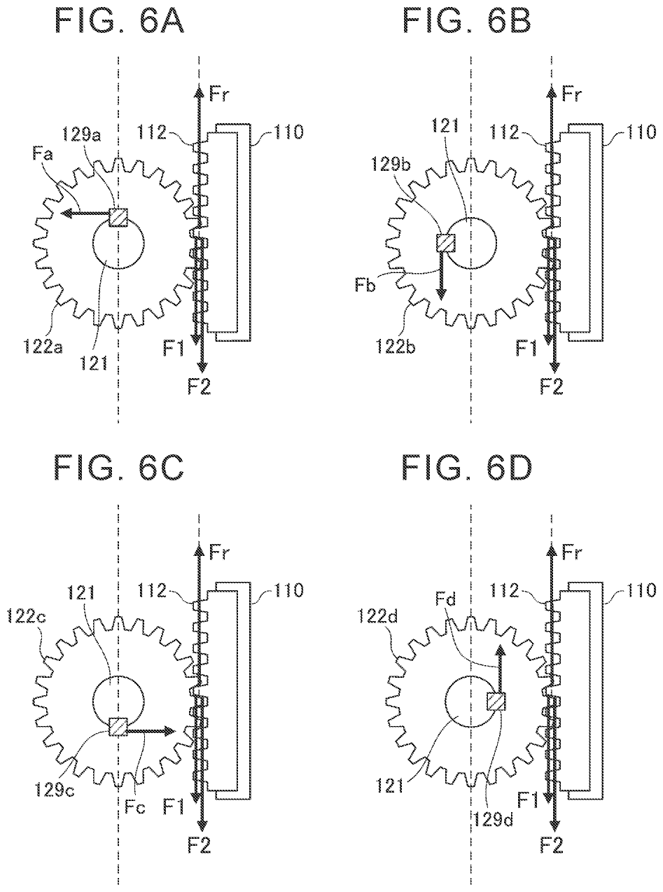

Other features of the manufacturing device 100 will be described. The plurality of pinion gears 122 (contact pieces) and engagement points of the shaft 121 are dispersed around the shaft 121 when viewed from the X direction. This will be explained with reference to FIGS. 4 and FIGS. 6A, 6B, 6C, and 6D. As shown in FIG. 4, the four pinion gears 122 from the bottom of the figure are denoted by reference signs 122a, 122b, 122c, and 122d.

FIGS. 6A to 6D show the engagement states of each of the pinion gears 122a, 122b, 122c, and 122d and the shaft 121. The shaft 121 and pinion gear 122a are engaged via a key 129a. Similarly, the shaft 121 and the pinion gear 122b (122c, 122d) are engaged via a key 129b (129c, 129d). The keys 129a to 129d are hatched in FIGS. 6A, 6B, 6C, and 6D to facilitate understanding. The keys 129a to 129d correspond to the engagement points between each of the pinion gears 122a to 122d and the shaft 121.

The engagement point (key 129a) between the pinion gear 122a and the shaft 121 is positioned directly above the shaft 121. At this time, of the pressure reaction force Fr, the force Fa caused by the torsional rigidity Ky is directed leftward in the figure, as shown in FIG. 6A. The engagement point (key 129b) between the pinion gear 122b and the shaft 121 is located on the left side of the shaft 121 (FIG. 6B). At this time, of the pressure reaction force Fr, the force Fb caused by the torsional rigidity Ky is directed downward in the figure, as shown in FIG. 6B. The engagement point (key 129c) between the pinion gear 122c and the shaft 121 is located below the shaft 121 (FIG. 6C). At this time, of the pressure reaction force Fr, the force Fc caused by the torsional rigidity Ky is directed rightward in the figure, as shown in FIG. 6C. The engagement point (key 129d) between the pinion gear 122d and the shaft 121 is located on the right side of the shaft 121 (FIG. 6D). At this time, of the pressure reaction force Fr, the force Fd caused by the torsional rigidity Ky is directed upward in the figure, as shown in FIG. 6D.

In this way, when the engagement points (keys 129a to 129d) between the plurality of pinion gears 122 (contact pieces) and the shaft 121 are dispersed around the shaft 121 when viewed from the X direction (stacking direction), the moment acting on the shaft 121 (the force caused by the torsional rigidity Ky) is applied evenly around the shaft 121. Since the force (moment) is evenly applied to the shaft 121, the torsion of the shaft 121 is not biased.

The engagement points between the pinion gears 122 other than the pinion gears 122a to 122d and the shaft 121 are also dispersed along the circumference of the shaft 122 when viewed from the X direction. It is only necessary that the engagement points between the plurality of pinion gears 122 and the shaft 121 are dispersed along the circumference of the shaft 121 when viewed in the X direction.

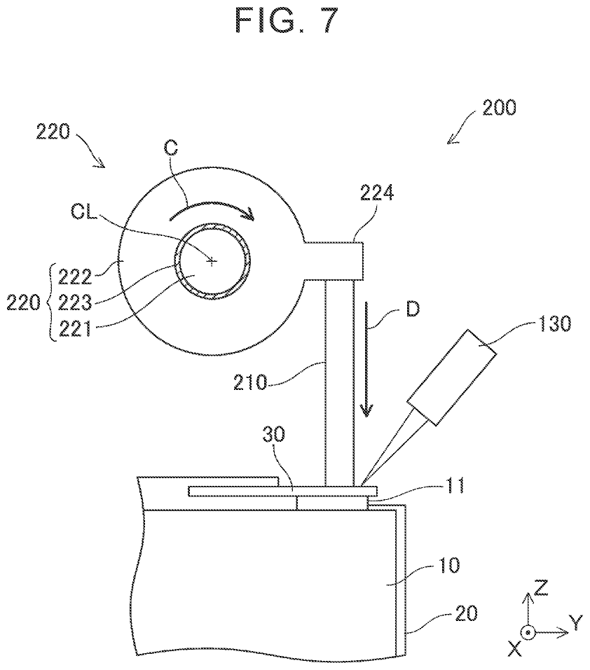

(Modification) FIG. 7 shows a side view of a manufacturing device 200 of a modification. In the manufacturing device 100 of the embodiment, the pressing piece 110 has the rack gear 112 and the rotor 120 has the pinion gear 122. In the modification of FIG.

7, the rotor 220 has a contact piece 222 with one protrusion 224. Also, the pressing piece 210 is a simple bar with no rack gear.

The contact piece 222 is engaged with the shaft 221 and has the protrusion 224 on its edge. The protrusion 224 is in contact with the upper end of the pressing piece 210. As shown in FIG. 7, when the shaft 221 rotates in the direction of the arrow C, the pressing piece 210 is pushed in the direction of the arrow D, and the pressing piece 210 presses the busbar 30 against the terminal 11.

The shaft 221 and the contact piece 222 are engaged via a torsion spring 223. In FIG. 7, the torsion spring 223 is hatched to facilitate understanding. The torsion spring 223 has elasticity in the circumferential direction of the shaft 221 (rotational direction of the shaft 221). The rotor 220 has a plurality of contact pieces 222 corresponding to the plurality of battery cells 10 of the assembled battery. The heights of the busbars 30 corresponding to the respective terminals 11 of the plurality of battery cells 10 may vary. Even if the heights of the busbars 30 vary, the torsion spring 223 absorbs the variation and pushes the busbars 30 with substantially the same force.

The shaft 121 of the rotor 120 of the embodiment and each contact piece (pinion gear 122) may be engaged via a torsion spring.

Points to be noted regarding the technique described in the embodiment will be described. The stack (the stack of the plurality of battery cells 10 and the plurality of separators 20) set in the manufacturing device 100 is arranged in the X direction of the coordinate system in the figures. The manufacturing device 100 includes the plurality of pressing pieces 110 arranged in the X direction. Each pressing piece 110 is supported by the housing 101 of the device so as to be swingable in the Z direction.

The manufacturing device 100 has the rotor 120. The rotor 120 extends along the X direction and is rotated around the axis CL by the motor 124. The rotor 120 has the shaft 121 and the plurality of pinion gears 122. When the rotor 120 rotates around the axis CL, the rotor 120 moves each of the pressing pieces 110 toward the corresponding busbar 30. The pressing piece 110 that has moved presses the facing busbar 30 and presses the busbar 30 against the corresponding terminal 11.

The X direction in the figures corresponds to the first direction, and the Z direction corresponds to the second direction. The “assembled battery” may also be expressed as a “battery pack.”

Although the specific examples have been described in detail above, these are merely examples and do not limit the scope of claims. The techniques described in the claims include various modifications and alternations of the specific example illustrated above. The technical elements described in the present specification or the drawings exhibit technical usefulness alone or in various combinations, and are not limited to the combinations described in the claims at the time of filing. In addition, the techniques illustrated in the present specification or drawings can achieve a plurality of objectives at the same time, and achieving one of the objectives itself has technical usefulness.

What is claimed is:

1. A manufacturing device for an assembled battery, the assembled battery including a plurality of battery cells stacked in a first direction, each battery cell including a terminal on a surface facing a second direction that intersects the first direction, and a busbar being welded to the terminal, the manufacturing device comprising:
a plurality of pressing pieces arranged along the first direction, a tip of each of the pressing pieces in the second direction facing the respective terminal with the busbar interposed between the pressing piece and the terminal;
a rotor that extends along the first direction and that is rotated by an actuator, the rotor being engaged with the pressing pieces and being configured to press the pressing pieces against the busbars when rotated about an axis; and
a welder that welds the busbars and the terminals, wherein the welder welds the busbars to the terminals while the rotor presses the busbars against the terminals.

2. The manufacturing device according to claim 1, wherein
the rotor includes a shaft rotated by the actuator and a plurality of contact pieces engaged with the shaft, and
each of the contact pieces is in contact with the corresponding one of the pressing pieces.

3. The manufacturing device according to claim 2, wherein engagement points between the contact pieces and the shaft are dispersed around the shaft when viewed from the first direction.

4. The manufacturing device according to claim 2, wherein a spring having elasticity in a circumferential direction of the shaft is interposed between the shaft and each of the contact pieces.

5. The manufacturing device according to claim 2, wherein the contact piece is a pinion gear, and the pressing piece is provided with a rack gear that engages with the pinion gear.
